(19) United States
(12) Patent Application Publication
(10) Pub. No.: US 2024/0394493 A1
(43) Pub. Date: Nov. 28, 2024

(54) IMAGE FORMING APPARATUS AND CONTROL METHOD THEREOF

(71) Applicant: CANON KABUSHIKI KAISHA, Tokyo (JP)

(72) Inventor: RIKO MIURA, Chiba (JP)

(21) Appl. No.: 18/672,607

(22) Filed: May 23, 2024

(30) Foreign Application Priority Data
May 23, 2023 (JP) 2023-084305

(51) Int. Cl. G06K 15/02; H04N 1/00

(52) U.S. Cl. CPC G06K 15/027; H04N 1/00798; H04N 2201/0081

(57) ABSTRACT

An image forming apparatus includes an acquisition unit configured to acquire image defect information, an image forming unit including a plurality of parts and configured to form a diagnostic image, a reading unit configured to read the diagnostic image formed by the image forming unit, and a control unit configured to perform control to diagnose a malfunctioning part in the image forming unit, based on the diagnostic image read by the reading unit, wherein the diagnostic image is an image based on the acquired image defect information and setting information about the image forming unit.

### BACKGROUND

### Field

The present disclosure relates to an image forming apparatus and a control method thereof.

### Description of the Related Art

There is an image diagnostic technique that is applicable to an image forming apparatus including a print unit and an image reading unit. In this technique, the image reading unit reads a diagnostic chart printed by the print unit, and image data obtained by the reading is used to diagnose a malfunctioning part in the image forming apparatus. Japanese Patent Application Laid-Open No. 2007-281959 discusses a technique of selecting a test chart to be used in a malfunction diagnostic determination. A defect type group is determined from a projection waveform, and a test chart is selected from among test charts classified as a dot stain test chart, a line stain test chart, or the like. As a result, printing of unnecessary test charts is prevented.

Japanese Patent Application Laid-Open No. 2007-281959, however, does not use the previous image diagnosis result in determination of the type of the image diagnostic chart. This does not lead to an effective reduction in the number of chart sheets or the usage of color material for the charts.

### SUMMARY

According to an aspect of the present disclosure, an image forming apparatus includes at least one memory storing instructions, at least one processor which, upon execution of the stored instructions configures that at least one processor to function as an acquisition unit configured to acquire image defect information, an image forming unit including a plurality of parts and configured to form a diagnostic image, a reading unit configured to read the diagnostic image formed by the image forming unit, and a control unit configured to perform control to diagnose a malfunctioning part in the image forming unit, based on the diagnostic image read by the reading unit, wherein the diagnostic image is an image based on the acquired image defect information and setting information about the image forming unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a network configuration including a print system.

FIG. 2 is a diagram illustrating an example of a hardware configuration of an image forming apparatus.

FIG. 3 is a block diagram illustrating an internal configuration of the image forming apparatus, an external controller, and a client personal computer (PC).

FIG. 4 is a flowchart illustrating a procedure of an image diagnostic process.

FIG. 5 is a flowchart illustrating a procedure of a test chart print process.

FIG. 6 is a diagram illustrating an example of a table indicating periods and sheet number conditions of each model.

FIG. 7 is a diagram illustrating an example of setting of a print area condition.

FIG. 8 is a diagram illustrating an example in which test chart data is generated by combining a plurality of print area conditions.

FIG. 9 is a flowchart illustrating a procedure of a test chart print process according to a second exemplary embodiment.

FIG. 10 is a flowchart illustrating a procedure of a test chart print process according to a third exemplary embodiment.

FIG. 11 is a diagram schematically illustrating a screen for receiving an input to set whether to use defect information.

FIG. 12 is a diagram illustrating an example of page description language (PDL) data for a colored band.

### DESCRIPTION OF THE EMBODIMENTS

Hereinafter, exemplary embodiments of the present disclosure will be described in detail with reference to the accompanying drawings. The following embodiments do not limit the present disclosure according to the scope of claims, and all combinations of features described in the exemplary embodiments are not necessarily mandatory to the solving means of the present disclosure. The same reference numerals are given to the same components, and the description thereof will be omitted.

### <Overall System Configuration>

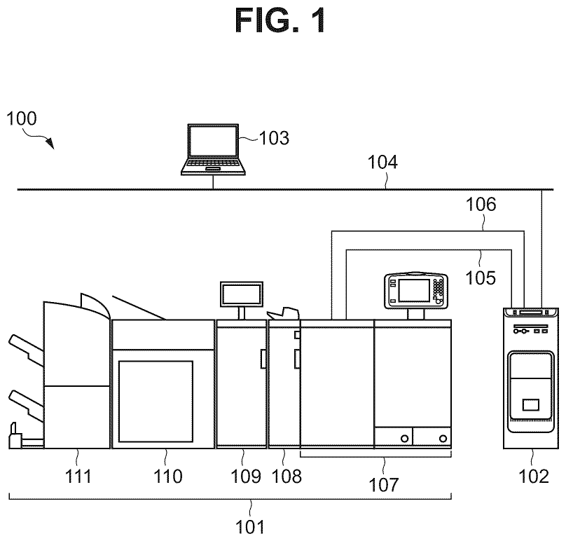

FIG. 1 illustrates an example of a network configuration including a print system (an image processing system) 100 according to a first exemplary embodiment. As illustrated in FIG. 1, the print system 100 includes an image forming apparatus 101 and an external controller 102. The image forming apparatus 101 and the external controller 102 are connected to each other via an internal local area network (LAN) 105 and a video cable 106 in such a manner that the image forming apparatus 101 and the external controller 102 communicate with each other. The external controller 102 is connected to a client personal computer (PC) 103 via an external LAN 104 in such a manner that the external controller 102 and the client PC 103 communicate with each other.

The client PC 103 transmits a print instruction to the external controller 102 via the external LAN 104. A printer driver is installed in the client PC 103, and the printer driver has a function of converting image data, which is a print process target, into page description language (PDL) data that is processable by the external controller 102. By operating the client PC 103, a user who wishes to execute printing can transmit a print instruction from one of various kinds of applications installed in the client PC 103 via the printer driver. The printer driver transmits the PDL data, which is print data, to the external controller 102, based on the print instruction from the user. The PDL data is print data specified by the user or data generated or selected in the client PC 103. In response to receipt of the PDL data from the client PC 103, the external controller 102 analyzes and interprets the received PDL data. Based on the interpretation result, the external controller 102 executes a rasterization process to generate a bitmap image (print image data) having a resolution suitable for the image forming apparatus 101. Then, the external controller 102 transmits a print instruction by transmitting a print job to the image forming apparatus 101.

Next, the image forming apparatus 101 will be described. In the image forming apparatus 101, a plurality of devices having different functions are connected to one another, which allows the image forming apparatus 101 to perform complex print processes, such as bookbinding.

The image forming apparatus 101 includes a print module 107 (an image forming unit), an inserter 108, a diagnostic unit 109, a stacker 110, and a finisher 111. These modules will be hereinafter described.

The print module 107 prints an image based on a print job and discharges a printed recording material. The printed recording material discharged by the print module 107 is conveyed through the inside of the diagnostic unit 109, the stacker 110, and the finisher 111 in this order. While the image forming apparatus 101 of the print system 100 is an image forming apparatus in the present exemplary embodiment, the print module 107 included in the image forming apparatus 101 may also be referred to as an image forming apparatus, as needed. The print module 107 forms (prints) an image by applying toner (color material) to a recording material fed and conveyed from a sheet feeding unit disposed in a lower portion of the print module 107.

The inserter 108 is a device for inserting, for example, divider materials for dividing a series of recording material groups conveyed from the print module 107, for example, at any selected locations.

The diagnostic unit 109 is a device that executes a diagnostic determination of presence or absence of a malfunctioning part in the image forming apparatus 101, based on a printed recording material on which an image has been printed by the print module 107 and which has been conveyed along a conveyance path. Specifically, the diagnostic unit 109 reads an image printed on a conveyed printed recording material and executes the diagnostic determination from the read image. In the malfunction diagnosis, a defect is detected from a difference in read signal value in the read image, and a malfunction part is determined based on information about the detected detect. The process of the diagnostic unit 109 will be described in detail below. The application of the diagnostic unit 109 is not limited to the above-described example. The print system 100 may additionally include a quality inspection system for an inspection of presence or absence of a print defect of a printed recording material.

The stacker 110 is a device in which a plurality of printed recording materials is stacked. The finisher 111 is a device that executes finishing processes, such as stapling, punching, and saddle stitching bookbinding, on conveyed printed recording materials.

Recording materials processed by the finisher 111 are discharged to a predetermined discharge tray.

While the external controller 102 is connected to the image forming apparatus 101 in the configuration example illustrated in FIG. 1, the present exemplary embodiment is also applicable to a different configuration. For example, the image forming apparatus 101 may be connected to the external LAN 104, and print data may be transmitted from the client PC 103 to the image forming apparatus 101, without involving the external controller 102. In this case, the image forming apparatus 101 executes the data analysis and rasterization on the print data.

### <Hardware Configuration of Image Forming Apparatus 101>

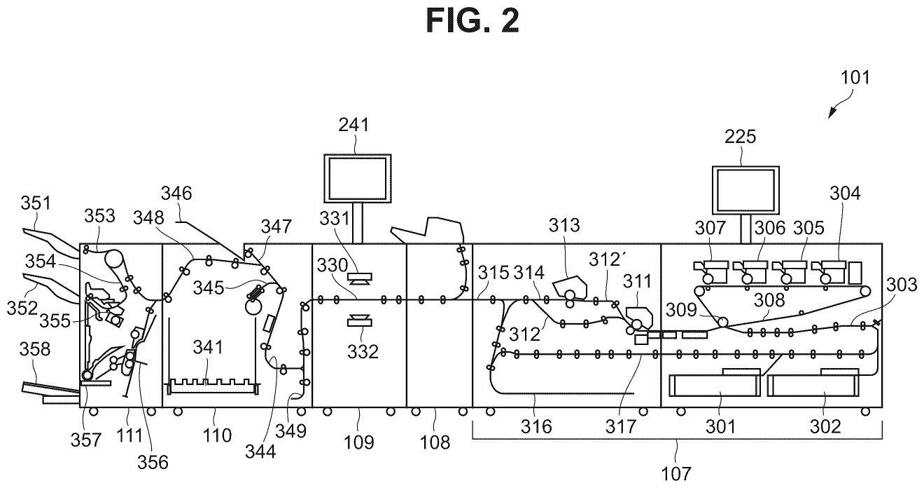

FIG. 2 is a sectional view illustrating a hardware configuration example of the image forming apparatus 101. Hereinafter, a specific operation example of the image forming apparatus 101 will be described with reference to FIG. 2.

Various kinds of recording materials are stored in sheet feeding decks 301 and 302 of the print module 107. The topmost one of the recording materials stored in one of the sheet feeding decks 301 and 302 is separated from the other recording materials, and is fed to a conveyance path 303. Image forming stations 304 to 307 each include a photosensitive drum (a photosensitive member). These image forming stations 304 to 307 form toner images on their respective photosensitive drums by using toner of their individual colors. Specifically, the image forming stations 304 to 307 use toner of yellow (Y), magenta (M), cyan (C), and black (K), respectively, to form their individual toner images.

The toner images of the individual colors formed by the image forming stations 304 to 307 are sequentially superimposed on top of one another and transferred (primary transfer) onto an intermediate transfer belt 308. As the intermediate transfer belt 308 rotates, the toner images, which have been transferred to the intermediate transfer belt 308, are conveyed to a secondary transfer portion 309. At the secondary transfer portion 309, the toner images are transferred (secondary transfer) from the intermediate transfer belt 308 to the recording material, which has been conveyed along the conveyance path 303. After the secondary transfer, the recording material is conveyed to a fixing unit 311. The fixing unit 311 includes a pressing roller and a heating roller. The fixing unit 311 executes a fixing process to fix the toner image to the recording material by applying heat and pressure to the recording material during passage of the recording material between the pressing roller and the heating roller. After passing through the fixing unit 311, the recording material is conveyed along a conveyance path 312 to a connection point 315 between the print module 107 and the diagnostic unit 109. In this way, a colored image is formed (printed) on the recording material.

Depending on the kind of the recording material, an additional fixing process may be needed. In this case, the recording material, which has passed through the fixing unit 311, is guided to a conveyance path 314 on which a fixing unit 313 is disposed. This fixing unit 313 executes the additional fixing process on the recording material being conveyed along the conveyance path 314. After passing through the fixing unit 313, the recording material is conveyed to the connection point 315. In a case where an operation mode for double-sided printing is set, the recording material, which has an image printed on its first side and which has been conveyed along the conveyance path 312 or the conveyance path 314, is guided to a reversing path 316. The recording material, which has been reversed by the reversing path 316, is guided to a double-sided printing conveyance path 317 and is conveyed to the secondary transfer portion 309. In this way, a toner image is transferred to a second side of the recording material, the second side being the side opposite to the first side, at the secondary transfer portion 309. Then, the recording material passes through the fixing unit 311 (and the fixing unit 313), whereby a colored image is formed on the second side of the recording material.

The printed recording material, on which an image has been formed (printed) by the print module 107 and which has been conveyed to the connection point 315, is next conveyed into the diagnostic unit 109 via the inserter 108.

The diagnostic unit 109 includes image reading units 331 and 332 each having a contact image sensor (CIS) along a conveyance path 330 through which the printed recording material from the print module 107 is conveyed. The image reading units 331 and 332 are disposed to face each other with the conveyance path 330 interposed therebetween. The image reading unit 331 is configured to read the top surface (the first side) of a recording material, and the image reading unit 332 is configured to read the bottom surface (the second side) of the recording material. For example, the image reading units 331 and 332 may each be configured by using a charge-coupled device (CCD) or a line scan camera, instead of a CIS.

The diagnostic unit 109 executes an image diagnostic process (image diagnostic determination) to determine presence or absence of a malfunctioning part in the image forming apparatus 101, based on an image printed on the printed recording material conveyed through the conveyance path 330. Specifically, at a timing when the printed recording material being conveyed reaches a predetermined position, the diagnostic unit 109 executes a read process to read a printed image on the recording material by using the image reading units 331 and 332.

The diagnostic unit 109 operates based on a user instruction for executing the image diagnostic process. It is desirable that the image diagnostic process be executed before a print operation is started or when defective printing consecutively occurs, for example. Recording materials passed through the diagnostic unit 109 are sequentially conveyed to the stacker 110.

The stacker 110 includes a stack tray 341 serving as a tray on which the printed recording materials, which have been conveyed from the diagnostic unit 109 disposed upstream in the conveyance direction of the printed recording materials, are stacked. The printed recording material passed through the diagnostic unit 109 is conveyed through a conveyance path 344 in the stacker 110. The printed recording material conveyed through the conveyance path 344 is guided to a conveyance path 345 and is stacked on the stack tray 341.

The stacker 110 further includes an escape tray 346 as a discharge tray. In the present exemplary embodiment, the escape tray 346 is used to discharge a recording material on which a test chart used in the image diagnostic determination by the diagnostic unit 109 has been recorded. The printed recording material conveyed through the conveyance path 344 is guided to a conveyance path 347 and is conveyed to the escape tray 346. The printed recording material that has not been stacked in or discharged from the stacker 110 is conveyed through a conveyance path 348 to the finisher 111 downstream of the stacker 110.

The stacker 110 further includes a reversing path 349 to reverse the orientation of a conveyed printed recording material. For example, the reversing path 349 is used to match the orientation of a recording material conveyed into the stacker 110 and the orientation of a printed recording material stacked on the stack tray 341 and taken out from the stacker 110. The reversing operation using the reversing path 349 is not executed on a printed recording material that will not be stacked in the stacker 110 but will be conveyed to the finisher 111.

The finisher 111 executes a finishing function specified by the user on printed recording materials conveyed from the diagnostic unit 109 disposed upstream in the conveyance direction of the printed recording materials. In the present exemplary embodiment, for example, the finisher 111 has finishing functions, such as a stapling function (one location or two locations), a punching function (two holes or three holes), and a saddle stitching bookbinding function. The finisher 111 includes two discharge trays 351 and 352. In a case where no finishing processes are executed by the finisher 111, the printed recording material conveyed to the finisher 111 is conveyed through a conveyance path 353 and is discharged to the discharge tray 351. In a case where a finishing process, such as a stapling process, is executed by the finisher 111, the printed recording material conveyed to the finisher 111 is guided to a conveyance path 354. The finisher 111 executes a finishing process specified by the user on the printed recording material conveyed through the conveyance path 354 by using a finishing process unit 355. The printed recording material on which the finishing process has been executed is discharged to the discharge tray 352.

### <Functional Configuration Diagram>

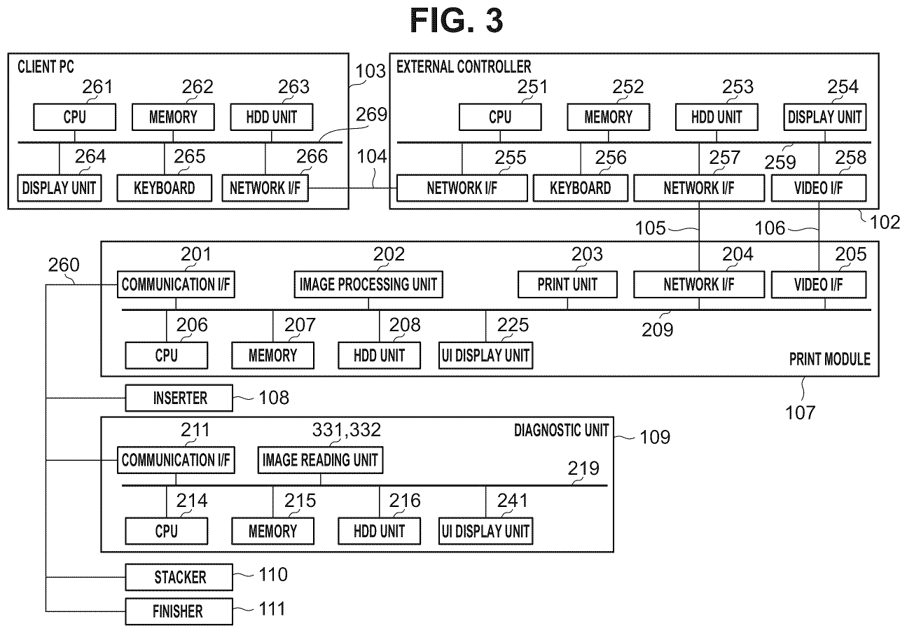

FIG. 3 schematically illustrates functional blocks of the image forming apparatus 101, the external controller 102, and the client PC 103.

The print module 107 of the image forming apparatus 101 includes a communication interface (I/F) 201, a network I/F 204, a video I/F 205, a central processing unit (CPU) 206, a memory 207, a hard disk drive (HDD) unit 208, and a user interface (UI) display unit 225. The print module 107 further includes an image processing unit 202 and a print unit 203. These components are connected to each other via a system bus 209 such that these components can transmit and receive data. The communication I/F 201 is connected to the diagnostic unit 109, the stacker 110, and the finisher 111 via a communication cable 260. The CPU 206 executes communications for controlling the individual devices via the communication I/F 201. The network I/F 204 is connected to the external controller 102 via the internal LAN 105, and is used for communications of control data, etc. The video I/F 205 is connected to the external controller 102 via the video cable 106, and is used for communications of data such as image data. If the external controller 102 can control the operation of the image forming apparatus 101, the print module 107 (the image forming apparatus 101) and the external controller 102 may be connected to each other only by the video cable 106. Various kinds of programs or data are stored in the HDD unit 208. The CPU 206 controls the overall operation of the print module 107 by executing programs stored in the HDD unit 208. Programs and data to be used by the CPU 206 in execution of various kinds of processes are stored in the memory 207. The memory 207 operates as a work area of the CPU 206. The UI display unit 225 receives input of various kinds of settings and operational instructions from the user, and is used for displaying various kinds of information, such as setting information and print job process statuses. For example, the UI display unit 225 receives various kinds of instructions, such as a diagnostic determination execution instruction, diagnostic settings, and sheet information settings from the user.

The diagnostic unit 109 includes a communication I/F 211, a CPU 214, a memory 215, an HDD unit 216 (a storage unit), the image reading units 331 and 332, and a UI display unit 241. These devices are connected to each other via a system bus 219 such that these devices can transmit and receive data. The communication I/F 211 is connected to the print module 107 via the communication cable 260. The CPU 214 executes communications to control the diagnostic unit 109 via the communication I/F 211. The CPU 214 controls the operation of the diagnostic unit 109 by executing control programs stored in the memory 215. A control program for the diagnostic unit 109 is stored in the memory 215. The image reading units 331 and 332 read images formed on the conveyed recording material in accordance with instructions from the CPU 214. The CPU 214 executes a diagnostic determination for presence or absence of a malfunctioning part in the image forming apparatus 101, based on diagnostic images read by the image reading units 331 and 332. The UI display unit 241 is used to display a diagnostic determination result, a setting screen, etc. The UI display unit 241 is also used as an operation unit, and is operated by the user. For example, the UI display unit 241 receives various kinds of instructions, such as a change of a setting of the diagnostic unit 109 and an instruction for executing the image diagnostic determination, from the user. Various kinds of setting information and image data to be used in the image diagnostic determination are stored in the HDD unit 216. Various kinds of setting information and image data stored in the HDD unit 216 are reusable.

The stacker 110 executes a control operation such that the printed recording material conveyed through the conveyance path 344 is discharged to the stack tray 341 or the escape tray 346 or is conveyed to the finisher 111 connected downstream in the conveyance direction of the printed recording material.

The finisher 111 executes a finishing process, such as stapling, punching, or saddle stitching bookbinding by controlling conveyance and discharge of the printed recording materials.

The external controller 102 includes a CPU 251, a memory 252, an HDD unit 253, a keyboard 256, a display unit 254, network I/Fs 255 and 257, and a video I/F 258. These devices are connected to each other via a system bus 259 such that these devices can transmit and receive data. By executing programs stored in the HDD unit 253, the CPU 251 controls the overall operation of the external controller 102, such as reception of print data from the client PC 103, a raster image process (RIP), and transmission of print data to the image forming apparatus 101, for example. Programs and data to be used by the CPU 251 in execution of various kinds of processes are stored in the memory 252. The memory 252 operates as a work area of the CPU 251.

Various kinds of programs and data are stored in the HDD unit 253. The keyboard 256 is used by the user in an entry of operational instructions to the external controller 102. For example, the display unit 254 is a display and is used in displaying of information about an application being executed in the external controller 102 and in displaying of an operation screen. The network I/F 255 is connected to the client PC 103 via the external LAN 104 and is used in data communication such as for print instructions. The network I/F 257 is connected to the print module 107 via the internal LAN 105 and is used in data communication such as for print instructions. The external controller 102 is configured to communicate with the print module 107, the diagnostic unit 109, the stacker 110, and the finisher 111 via the internal LAN 105 and the communication cable 260. The video I/F 258 is connected to the print module 107 via the video cable 106 and is used for data communication such as for image data (print data).

The client PC 103 includes a CPU 261, a memory 262, an HDD unit 263, a display unit 264, a keyboard 265, and a network I/F 266. These devices are connected to each other via a system bus 269 such that these devices can transmit and receive data. The CPU 261 controls the operation of the individual devices via the system bus 269 by executing programs stored in the HDD unit 263. In this way, the client PC 103 executes various kinds of processes. For example, by executing a document processing program stored in the HDD unit 263, the CPU 261 generates print data and outputs print instructions. Programs and data to be used by the CPU 261 in execution of various kinds of processes are stored in the memory 262. The memory 262 operates as a work area of the CPU 261.

For example, various kinds of applications, such as the document processing program, programs such as for the printer driver, and various kinds of data are stored in the HDD unit 263. For example, the display unit 264 is a display and is used for displaying of information about an application being executed by the client PC 103 and for displaying of an operation screen. The keyboard 265 is used by the user in an entry of operational instructions to the client PC 103. The network I/F 266 is connected to the external controller 102 via the external LAN 104 such that the client PC 103 can communicate with the external controller 102. The CPU 261 communicates with the external controller 102 via the network I/F 266.

### <Image Diagnostic Process>

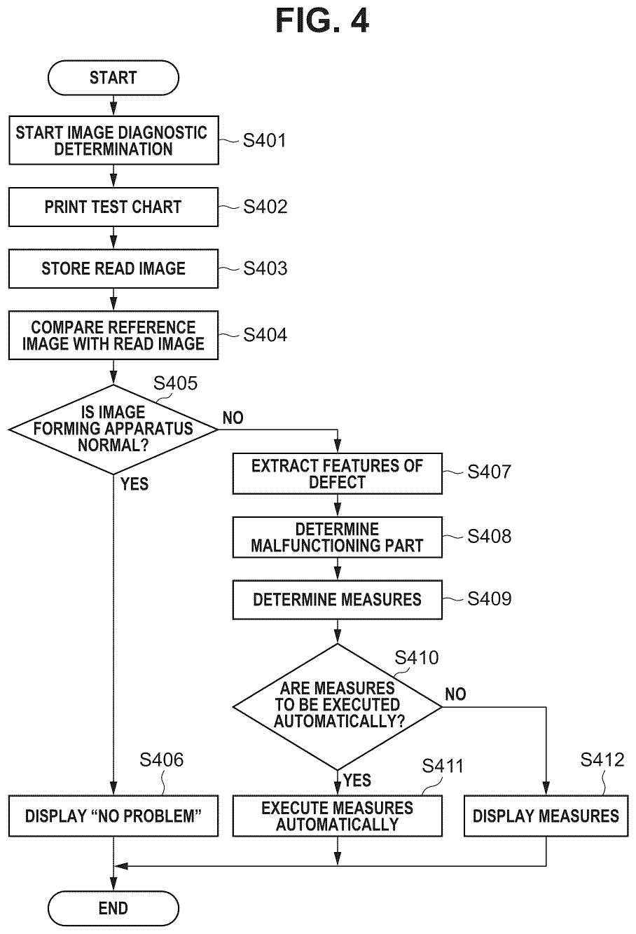

The image diagnostic process according to the present exemplary embodiment will be described with reference to drawings. FIG. 4 is a flowchart illustrating a procedure of the print operation executed by the print module 107 and the image diagnostic process that is executed by the diagnostic unit 109. FIG. 4 illustrates an overall procedure from an operation before the start of the image diagnostic determination to execution of the diagnosis. In the description of the flowchart, letter “S” represents step. The same representation will be used in the description of the other flowcharts. The steps in FIG. 4 are executed by the CPU 206 of the print module 107 and the CPU 214 of the diagnostic unit 109.

In step S401, the print system 100 receives an image diagnostic determination instruction from a user or a maintenance technician via the UI display unit 241, which is also used as an operation unit, and checks the settings of the image diagnostic process. In the present exemplary embodiment, for example, the print system 100 starts the image diagnostic process immediately after the print system 100 is turned on and started. After the start of the print system 100, a notification prompting a start of the diagnostic determination is displayed on at least one of the UI display unit 241, the display unit 254 of the external controller 102, and the UI display unit 225 of the print module 107, and the start of the diagnostic determination is prompted. The start timing of the image diagnostic process is not limited to the above-described example. The print system 100 may have an inspection function of inspecting presence or absence of a print defect of a printed recording material. In this case, in a case where the inspection function detects a defect consecutively, the start of the image diagnostic process may be prompted. Alternatively, a time for displaying a notification prompting execution of the image diagnostic process may be set in a timer, and the notification may be displayed at the set time.

In response to the user checking the notification prompting the start of the diagnostic determination, a screen that receives an image diagnostic determination start instruction is displayed on the UI display unit 241. In response to receipt of a start instruction, a sheet feeding deck containing sheets on which diagnostic test charts will be printed is selected as a setting of the image diagnostic determination. The diagnostic setting check process will be described in detail below. After completion of checking the image diagnostic setting, the processing proceeds to a test chart print process.

In step S402, the CPU 251 of the external controller 102 rasterizes a test chart (a diagnostic image) into a bitmap. The CPU 251 generates a bitmap obtained by rasterizing a test chart as a reference image. The test chart (the diagnostic image) is an image that the client PC 103 has instructed to print and that is used for a diagnosis of a defect in the image forming apparatus 101 (the test chart may also be referred to as a test image). Details of the test chart print instruction will be described below. Next, the print module 107 prints the test chart. The CPU 251 transmits the bitmap data of the rasterized test chart from the video I/F 258 to the video I/F 205 of the print module 107 via the video cable 106. The CPU 206 of the print module 107 executes a halftone process on the test chart bitmap data received via the video I/F 205, and the print unit 203 prints the test chart based on the image data on which the halftone process has been executed.

In step S403, the CPU 214 of the diagnostic unit 109 controls the image reading units 331 and 332 such that the printed test chart is read. The image obtained by reading the test chart is stored as a diagnostic image in the HDD unit 216 of the diagnostic unit 109. After the diagnostic image is stored, the processing proceeds to step S404.

In step S404, the CPU 214 compares a reference image with the read image to determine presence or absence of a malfunction in the print module 107. In the present exemplary embodiment, the CPU 214 compares the reference image and the read image and calculates a difference value between the reference image and the read image.

In a case where the calculated difference value is more than or equal to a preset threshold, the CPU 214 determines that a difference is present and sets 1 in difference image data. On the other hand, in a case where the calculated difference value is less than the threshold, the CPU 214 sets 0 in the difference image data.

The calculation method of the difference image data is not limited to the above-described example. In the present exemplary embodiment, an example in which an average value is calculated from a read image and is used as a reference signal has been described. However, a value estimated as a reference signal may be stored in advance in the HDD unit 216. The print system 100 may include a correction unit that corrects non-linearity between the signal value of the read images acquired by the image reading units 331 and 332 and the luminance. In this case, the difference image data may be calculated after the signal value of the read images is corrected. After the difference image data, which is binary data indicating presence or absence of a difference, is stored in the HDD unit 216, the processing proceeds to step S405.

After completion of generation of the difference image data, in step S405, the CPU 214 determines whether the image forming apparatus 101 is normal. In this determination, the CPU 214 determines whether the difference image data contains data containing 1. In a case where the CPU 214 obtains a determination result indicating that the image forming apparatus 101 is normal (YES in step S405), the processing proceeds to step S406. In step S406, the CPU 214 displays “no problem”, which is the diagnostic determination result indicating that the image forming apparatus 101 is normal, on the UI display unit 241 of the diagnostic unit 109. On the other hand, in a case where the CPU 214 obtains a determination result indicating that the image forming apparatus 101 is not normal (that the difference image data contains 1) (NO in step S405), the processing proceeds to step S407. In steps S407 to S412, based on the read image data and the difference image data, the CPU 214 determines a malfunctioning part in the image forming apparatus 101 and instructs measures to be executed.

In step S407, the CPU 214 extracts features that are used in a determination of a malfunctioning part in the print module 107, from the read image data and the difference image data. The CPU 214 extracts features of the difference from the read image corresponding to a differential area determined to be “difference is present” calculated from the difference image data in step S404. Examples of the feature information about the differential area obtained in this extraction process include color material information indicating which one of yellow, magenta, cyan, and black has caused the defect. Another example is contrast information indicating that the density contrast of the defect is represented by a positive or negative value. The positive value represents a difference in the darker direction (plus direction), and the negative value represents a difference in the lighter direction (minus direction). Other examples are size information such as the width of the defect (the size in the main-scanning direction) and the height of the defect (the size in the sub-scanning direction) and shape information such as dots, vertical lines, and horizontal lines. Other examples are coordinate information indicating a location in a direction perpendicular to the test chart conveyance direction in the print module 107 and periodical information indicating that defects having similar features occur periodically in the test chart conveyance direction in the print module 107. The extracted features are stored in the HDD unit 216, and the processing proceeds to step S408.

In step S408, based on the feature information about the differential area obtained in step S407, the CPU 214 determines a malfunctioning part (portion) causing the image defect in the print module 107 and the image reading unit 331. In the differential area, the CPU 214 selects a combination of areas having the same color and a high similarity and determines a malfunctioning part from the periodical information about the selected combination.

In step S409, the CPU 214 determines measures to be executed to correct the image defect, based on the malfunctioning part determined in step S408. There are measures that can be executed automatically and measures that can be executed manually. Examples of the former measures include those that can be executed by the print module 107, such as cleaning of a wire or a grid of a corona charger, which is a charging unit of a photosensitive drum disposed in each of the image forming stations 304 to 307 of the print module 107. Examples of the latter measures include the following two examples. The first example is measures that are executed by the user, such as cleaning the reading glass surface of the image reading unit 331 or 332 of the diagnostic unit 109 and adjusting the recording material to be used, or is measures that are executed by a maintenance technician, such as an exchange of parts. The second example is measures that are executed to correct abnormal reading by the image reading unit 331 or 332 or fiber, foreign matter, or the like, which has already been included in the recording materials before the execution of the image forming.

Next, in step S410, the CPU 214 determines whether the measures determined in step S409 is those that are executed automatically. In a case where the CPU 214 obtains a determination result indicating that the determined measures are to be executed automatically (YES in step S410), the processing proceeds to S411.

In step S411, the CPU 214 executes the automatic measures corresponding to the cause of the image defect.

In a case where the CPU 214 obtains a determination result indicating that the determined measures are not those that are to be executed automatically (NO in step S410), the processing proceeds to step S412. In step S412, the CPU 214 displays the image diagnostic determination result and the corresponding measures on the UI display unit 241 of the diagnostic unit 109. After any one of steps S406, S411, and S412, the CPU 214 ends the flowchart in FIG. 4 (the image diagnostic process).

### <Procedure of Test Chart Print Instruction Process in Step S402>

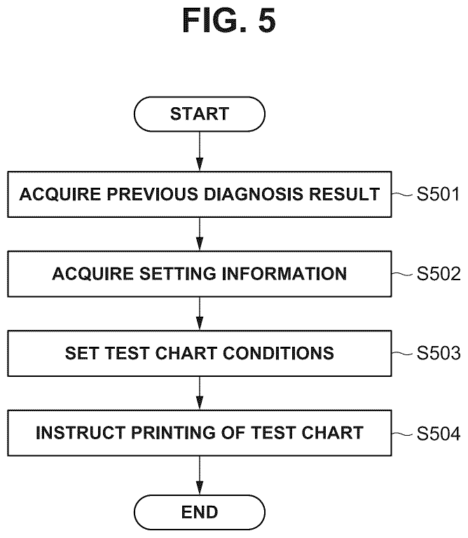

FIG. 5 is a flowchart illustrating a detailed procedure of the process for instructing printing of the test chart in step S402 in FIG. 4. In the present exemplary embodiment, a description will be given of a determination of a test chart to be used when a re-diagnostic determination is executed. This re-diagnostic determination is executed to determine whether the malfunctioning part has been corrected after execution of measures based on a result of the previous diagnosis.

In step S501, for example, the CPU 261 reads out the color material information, the size information, the shape information, the coordinate information, and the periodical information (diagnosis information) extracted in step S407 from the HDD unit 216 and acquires the defect information (information about the image defect).

Next, in step S502, the CPU 261 acquires the setting information about the image forming apparatus 101. For example, from the HDD unit 208, the CPU 261 reads out and acquires the setting information about the sheets set in cassettes and the current model information.

Next, in step S503, the CPU 261 sets test chart conditions (color, contrast, number of sheets, and print location) from the defect information and the setting information about the image forming apparatus 101. Details of the setting of the test chart conditions will be described below.

In step S504, the CPU 261 instructs printing of a test chart matching the set test chart conditions. The present exemplary embodiment uses a method for generating test chart data from the acquired sheet setting information and the test chart conditions and outputting a print instruction. The CPU 261 generates test chart data based on the sheet size indicated by the acquired sheet setting information and based on the color, the print area, and the number of sheets indicated by the test chart conditions. Next, the CPU 261 instructs the external controller 102 to print the generated test chart data. Details of the generation of the test chart data will be described below. The determination of the test chart data that is instructed to be printed is not limited to the above-described method in which the data is generated. Any data that satisfies the test chart conditions may be used. For example, a test chart satisfying the test chart conditions may be selected from the test chart data stored in advance in the HDD unit 263, the HDD unit 253, the HDD unit 208, etc. After completion of step S504, the CPU 261 ends the flowchart in FIG. 5 (the process for instructing printing of a test chart).

### <Setting of Test Chart Conditions>

A description will be given of a process for setting test chart conditions such that a defect becomes clearly observable from defect information and setting information about the image forming apparatus 101, which is the process in step S503 in FIG. 5. In the present exemplary embodiment, at least one of the test chart conditions, which are the test chart color condition, the sheet number condition, and the print area condition, is used. Hereinafter, a procedure of setting each condition will be described.

The color condition is set based on color material information and contrast information. For example, in a case where the contrast information indicates “plus”, a defect becomes clearly observable with the background density set to light. Thus, white is set as the color condition. On the other hand, in a case where the contrast information indicates “minus” and the color material information indicates magenta, a defect becomes clearly observable with the background density including darker magenta. Thus, magenta is set as the color information. In a case where the color material information indicates cyan, yellow, or black, the corresponding color is set. In a case where the color material information indicates a multi-color such as cyan and magenta, information indicating use of a multi-color is set as the color condition. The test chart color condition is not limited to the above-described example. Any color that makes a defect clearly observable may be used. For example, a plurality of colors including the color indicated by the color material information may be set. In the case of a multi-color, the color indicated by the color material information and a plurality of colors other than the color material information may be set.

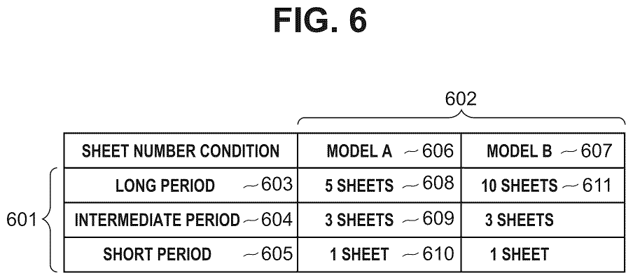

Next, setting of the sheet number condition will be described. The sheet number condition is set from the shape information, the periodical information, or the setting information about the image forming apparatus 101. First, a case that uses the shape information will be described. In a case where the periodicity of shapes, such as dots and horizontal lines, is checked to perform a diagnosis, 3 sheets is set as the sheet number condition. In a case of a vertical line for which the periodicity is not to be checked, there is no need to print a plurality of sheets. Thus, 1 sheet is set as the sheet number condition. Next, a case in which the sheet number condition is set from the periodical information and the setting information about the image forming apparatus 101 will be described. The number of sheets to be used in a determination of the periodicity varies depending on periodicity of the parts in the image forming apparatus 101. Thus, based on model information in the setting information about the image forming apparatus 101, the CPU 261 refers to the pre-stored table including periods and sheet number conditions of each model and determines a sheet number condition. FIG. 6 schematically illustrates a table including periodical information and sheet number conditions of each model. For example, in a case where model information 602 indicates model A 606 and in a case where periodical information 601 indicates a short period 605, the CPU 261 refers to data 610 in the sheet number condition table and sets one sheet. In a case where the periodical information 601 indicates an intermediate period 604, the CPU 261 refers to data 609 and sets three sheets. In a case where the periodical information 601 indicates a long period 603, the CPU 261 refers to data 608 and sets five sheets. In a case where the model information 602 indicates model B 607 and the periodical information 601 indicates the long period 603, the CPU 261 refers to data 611 and sets 10 sheets. The method for setting the sheet number condition is not limited to the method in which the CPU 261 refers to the table. Any method may be used as long as a necessary number of sheets is calculated. For example, parts information per model may be stored in advance, and a necessary number of sheets may be calculated based on the parts information.

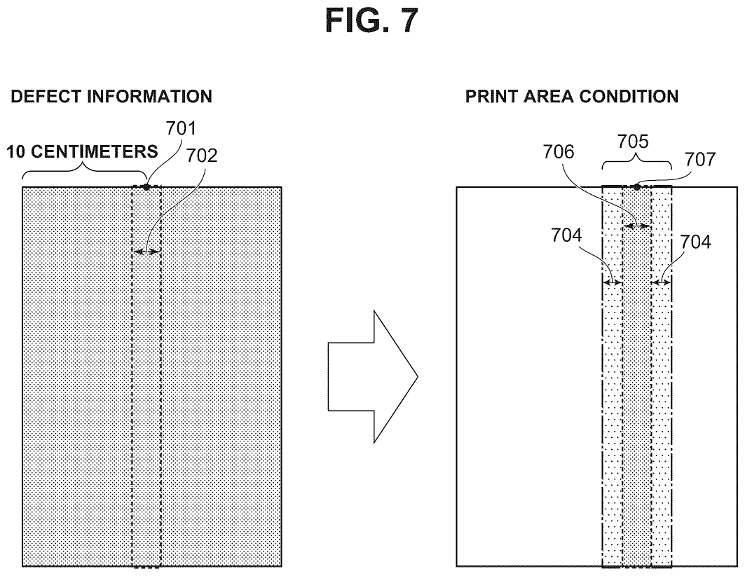

Next, setting of the print area condition will be described. Periodically occurring defects and vertical lines tend to occur at the same location in the main-scanning direction, and thus, checking a certain main-scanning range is sufficient. Accordingly, only a certain main-scanning range is inspected for a diagnosis by setting a print area condition. In the present exemplary embodiment, a print area condition is set by using coordinate information, periodical information, and size information. FIG. 7 schematically illustrates a print area condition set by using coordinate information and size information. The following description will be given of a case in which a defect having a width of one centimeter (cm) (size information 702) periodically occurs at a location (coordinate information 701) of 10 cm inside from the left end of a sheet in the main-scanning direction. A print area condition 706 is set by using the coordinate information 701, which indicates the location of 10 cm inside from the left end, as a center 707, and by using the one-centimeter width indicated by the size information 702 (from a location of 9.5 cm inside from the left end of the sheet to a location of 10.5 cm inside from the left end) as a print area. In addition, margins 704 each having 5 millimeters are added to set a width 705 that is from a location of 9 cm inside from the left end of the sheet to a location of 11 cm inside from the left end is set as a print area condition. A margin different from the one described above may be added as long as, for example, a deviation amount in the main-scanning direction in which a defect occurs or skew that occurs at reading is taken into account. A preset value may be used as described above or a range proportional to the size information may be set, such as 1.5 times of the size information.

A method for setting the test chart conditions from the defect information and the setting information about the image forming apparatus 101 has been described. While, in the above description, an individual condition is set from one item of defect information, a plurality of conditions may be set from a plurality of items of defect information. <Generation of Test Chart Data>

A method for generating the test chart data in step S504 in FIG. 5 will be described. In the present exemplary embodiment, a description will be given of a method for generating a chart from the test chart conditions and the sheet size information, which is setting information about the image forming apparatus 101.

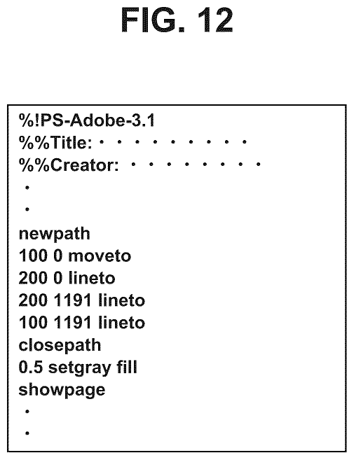

In a case where the test chart conditions indicate that the color condition is magenta and the sheet number condition is 3, the CPU 261 acquires the sheet size from the sheet size information, and generates test chart data indicating that a test chart of magenta 50% will be printed on the entire sheet size of three sheets. The color density is not limited to the above-described example. Any density that makes the defect become clearly observable may be used. In a case where a print area condition has been set, for example, the CPU 261 specifies pixels of start and end points of the print area condition in the main-scanning direction from the sheet size information, and generates PDL data such that a colored band will be printed between the start and end points (sub-scanning direction ends of the sheet will be filled). FIG. 12 illustrates an example of the PDL data. PDL data for printing a colored band of gray 50% will be described. In FIG. 12, “newpath” is a declaration for creating a new path, and “moveto” specifies the initial location. Numerical values “100 0” represent coordinates, meaning the location is at 100 points in the X direction and 0 point in the Y direction inside from the bottom left. One point is equivalent to 1/72 inches. In addition, “lineto” is a code for rendering of a trajectory of the movement. The trajectory indicates the movement from (100 0) to (200 0). That is, a line is formed. Similarly, the operation continues by moving to the remaining two points, so as to render lines. Next, with “close path”, the start point and end point are connected to each other, so that a rectangle (band) is rendered. Next, with “fill”, the rectangle (band) is filled with a specified color. In this case, “0.5 setgray” specifies gray 50%. Finally, with “showpage”, a print-out is output. The PDL data instructed to be printed out is analyzed, interpreted, and rasterized by the external controller 102 or the like. As a result, the PDL data is converted into a bitmap image (print image data) having a resolution suitable for the image forming apparatus 101 and is supplied as a print job. The method for generating data in a print area is not limited to the above-described example. Any method for generating data in a range including a print area may be used. For example, among a plurality of segmented blocks in the main-scanning direction, printing may be executed on a block including a print area condition. Alternatively, after on a data pattern is created on the entire surface, a process for reduction to a print condition range in the main-scanning direction may be executed.

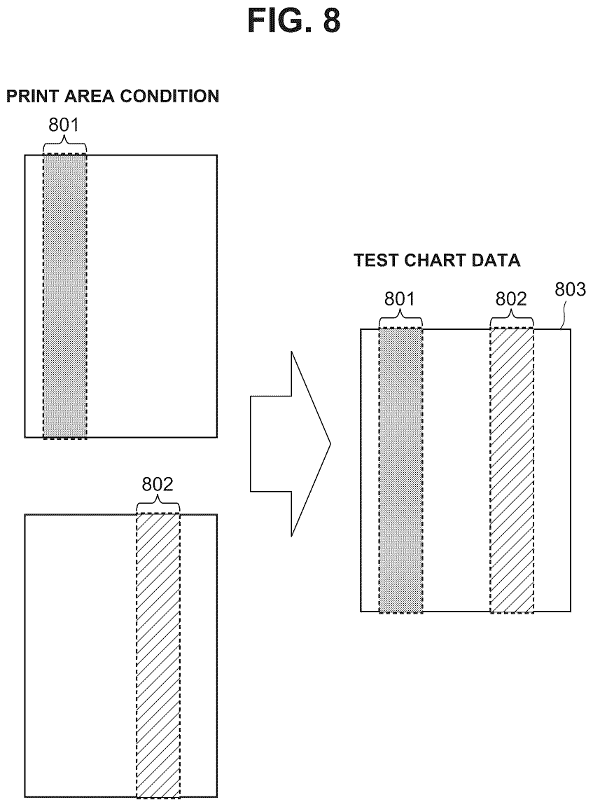

In a case where a plurality of conditions is set, each of the conditions may be handled separately or, some conditions may be combined together as far as applicable. For example, in a case where magenta and a multi-color are set as the color condition, test chart data is generated with colors including both conditions such as magenta 50% and cyan 50%. FIG. 8 illustrates an example of a combination of print area conditions. In a case where a print area condition 801 and a print area condition 802 are set, test chart data 803 is generated by combining these print areas on the same page.

The generation of the test chart data is not limited to the above-described example. A test pattern including test chart conditions may be selected from the test patterns stored in advance, for example, in the HDD unit 263, 253, or 208, and test chart data may be generated based on the sheet size information.

The above description has been given of a case in which diagnostic test chart conditions are set by using the defect information, which is the previous diagnosis result, and the setting information about the image forming apparatus 101, and printing of a test chart is instructed. By setting the test chart conditions, in a case, for example, in which a user or a maintenance technician executes a diagnostic determination for checking (re-diagnostic determination) after cleaning based on the previous diagnosis result, generation of unnecessary test charts is able to be reduced (limited).

An image diagnostic process according to a second exemplary embodiment will be described. In the first exemplary embodiment, test chart conditions are set by using defect information about the previous diagnosis when the image diagnostic process is executed. However, the advantageous effects of the present exemplary embodiment are not limited to those of the above-described example. For example, in a case where the print system 100 coordinates with a quality inspection system for detecting defects from images read from a printed material, the print system 100 may use defect information about defects detected by the quality inspection system. In the present exemplary embodiment, a quality inspection system is executed by the CPU 261 of the client PC 103, defect information is stored in the HDD unit 263 in a case where defects having similar defect features frequently occur, and the image diagnostic process is executed.

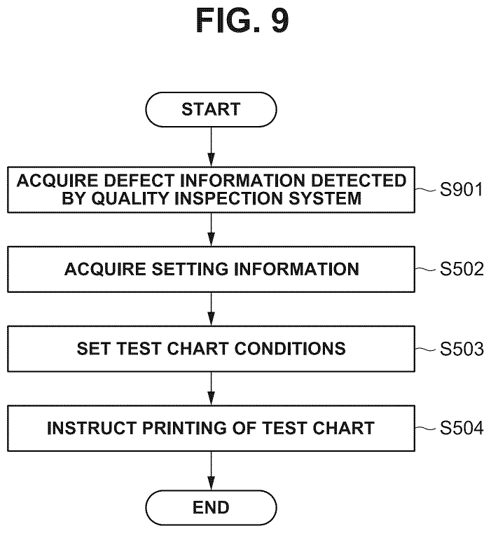

FIG. 9 illustrates a detailed procedure of a process for instructing printing of a test chart in step S402 according to the second exemplary embodiment. The configuration of the print system 100 and the flowchart of the image diagnostic process according to the present exemplary embodiment are basically the same as those according to the first exemplary embodiment, and the redundant description will be omitted. A description will be given of an image diagnostic process of step S901 that is different from the step in the first exemplary embodiment. The steps in FIG. 9 are executed by the CPU 261 of the client PC 103, as in the first exemplary embodiment.

In step S901, the CPU 261 reads and acquires defect feature information stored in the HDD unit 263. The defect information is feature information about defects that has been obtained by analyzing images of defects that have frequently occurred. As in the first exemplary embodiment, examples of the defect information include color material information indicating which one of the colors of yellow, magenta, cyan, black has caused a defect and contrast information indicating the density of the defect and whether the color is too light (minus) or too dark (plus). Other examples are size information and shape information such as dots, vertical lines, and horizontal lines. Other examples are coordinate information indicating a location in a direction perpendicular to the test chart conveyance direction in the print module 107 and periodical information indicating that defects having similar features in the test chart conveyance direction in the print module 107 occur periodically.

The subsequent steps are the same as those according to the first exemplary embodiment, and the redundant description will be omitted.

An example in which the CPU 261 sets test chart conditions by using defect information detected by a quality inspection system has thus been described. By using defect information detected by a quality inspection system, only the necessary test chart is able to be printed even in a case where the diagnostic determination is the initial diagnostic determination.

An image diagnostic process according to a third exemplary embodiment will be described. In the first and second exemplary embodiments, test chart conditions are set by using defect information. However, there can be a case in which the print system 100 executes the diagnostic determination without using any defect information in a case, for example, in which an initial diagnostic determination is executed by the print system 100 that does not coordinate with a quality inspection system.

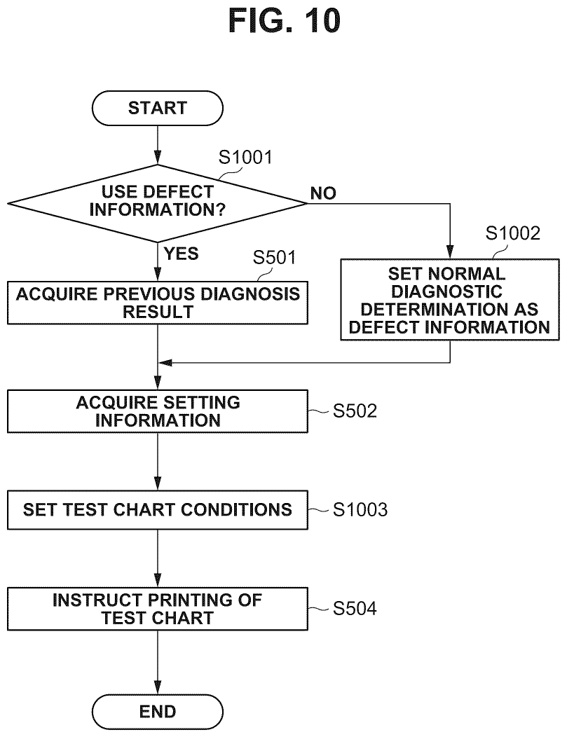

The following description will be given of an example case in which a determination of whether to use defect information is performed and test chart conditions are set. FIG. 10 illustrates a detailed procedure of a process for instructing printing of a test chart in step S402 according to the third exemplary embodiment. The configuration of the print system 100 and the flowchart of the image diagnostic process according to the present exemplary embodiment are basically the same as those according to the first exemplary embodiment, and the redundant description will be omitted. A description will be given of steps S1001 to 1003 that are different from the steps in the first exemplary embodiment. The steps in FIG. 10 are executed by the CPU 261 of the client PC 103 as in the first exemplary embodiment.

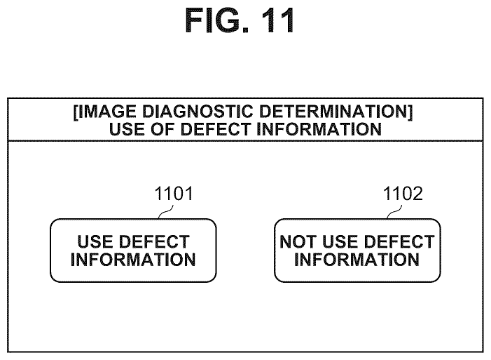

In step S1001, the CPU 261 determines whether to use defect information. In the present exemplary embodiment, in a case where the CPU 261 executes a re-diagnostic determination within a few hours from the previous diagnosis, the CPU 261 determines to use the defect information. In the quality inspection system, in a case where the defective rate within a short period is 10% or more or in a case where a defect has occurred at the same location in the main-scanning direction three or more times, the CPU 261 executes a diagnostic determination in coordination with the quality inspection system and determines to use the defect information. On the other hand, in a case where the CPU 261 executes an initial diagnostic determination in which the print system 100 does not coordinate with the quality inspection system or in a case where a certain period of time has elapsed from the previous diagnosis determination, the CPU 261 determines not to use any defect information. The determination of whether to use defect information is not limited the above-described example. Any method may be used as long as the determination of whether to use defect information is performed. For example, a screen as illustrated in FIG. 11 may be displayed on the UI display unit 241. In a case where a button 1101 is pressed, the CPU 261 determines to use the defect information, and in a case where a button 1102 is pressed, the CPU 261 determines not to use the defect information. In a case where the CPU 261 uses the defect information (YES in step S1001), the processing proceeds to step S501. Step S501 is the same as that in the first exemplary embodiment, and the redundant description will be omitted.

On the other hand, in a case where the CPU 261 determines not to use the defect information (NO in step S1001), the processing proceeds to step S1002.

In step S1002, the CPU 261 sets a normal diagnostic determination as the defect information, and the processing proceeds to step S502. Step S502 is the same as that in the first exemplary embodiment, and the redundant description will be omitted.

In step S1003, the CPU 261 sets test chart conditions that enable a defect diagnosis in a general way when the normal diagnostic determination is set as the defect information in step S1002. For example, all colors of cyan, magenta, yellow, black, and multi-color are set as the color condition. In the present exemplary embodiment, a diagnostic determination for a defect occurring with the long period is executed, after the normal diagnostic determination, in a case where there is a possibility for the defect occurring with the long period, and 3 sheets is set as the sheet number condition so that a defect occurring with a period other than the long period is checked. It is desirable that at least the intermediate transfer belt 308 be included as malfunction checking target parts in which a defect can occur with the long period. The print area condition is not set in such a manner that the entire page is to be diagnosed. Alternatively, the entire page is set as the print area condition. In a case where a diagnostic determination other than the normal diagnostic determination is set as the defect information, in step S1003, the CPU 261 sets the same test chart conditions as those in step S503. The subsequent step is the same as that according to the first exemplary embodiment, and the redundant description will be omitted.

An example in which the CPU 261 sets test chart conditions by determining whether to use defect information has been described. Executing the determination leads to, in a case where defect information is to be used, printing of a test chart optimal for the defect that the user wishes to check. In a case where defect information is not used, a general test chart is printed.

As described in the above exemplary embodiments, setting test chart conditions by using defect information and outputting a test chart leads to a reduction in printing of unnecessary test charts.

According to the exemplary embodiments of the present disclosure, a diagnosis of malfunctioning parts in an image forming apparatus is able to be performed without outputting unnecessary diagnostic images.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-084305, filed May 23, 2023, which is hereby incorporated by reference herein in its entirety.

What is claimed is:

1. An image forming apparatus comprising:
at least one memory storing instructions;
at least one processor which, upon execution of the stored instructions configures that at least one processor to function as:
an acquisition unit configured to acquire image defect information;
an image forming unit including a plurality of parts and configured to form a diagnostic image;
a reading unit configured to read the diagnostic image formed by the image forming unit; and
a control unit configured to perform control to diagnose a malfunctioning part in the image forming unit, based on the diagnostic image read by the reading unit,
wherein the diagnostic image is an image based on the acquired image defect information and setting information about the image forming unit.

2. The image forming apparatus according to claim 1, wherein the diagnostic image is an image generated based on the acquired image defect information and the setting information about the image forming unit.

3. The image forming apparatus according to claim 1, further comprising:
a storage unit configured to store diagnosis information obtained by the control unit,
wherein the image defect information is the diagnosis information stored in the storage unit.

4. The image forming apparatus according to claim 1, wherein the control unit causes the image forming unit to form the diagnostic image as a first diagnostic image, and in a case where the image defect information is not acquired, causes the image forming unit to form a second diagnostic image.

5. The image forming apparatus according to claim 4, wherein the second diagnostic image is a diagnostic image that enables diagnosis of a malfunctioning part regardless of an image defect feature.

6. The image forming apparatus according to claim 4, wherein the first diagnostic image is limited in at least one of a number of image sheets, an amount of color material, a number of colors, and a print area, by the image defect information in contrast to the second diagnostic image.

7. The image forming apparatus according to claim 1, wherein the image defect information is information about at least one of a color, a shape, a period, a location, and a size of an image defect.

8. The image forming apparatus according to claim 1, wherein the setting information about the image forming unit is at least one of a sheet size and model information.

9. A control method of an image forming apparatus including an image forming unit that includes a plurality of parts and forms a diagnostic image, and a reading unit that reads the diagnostic image formed by the image forming unit, the control method comprising:
acquiring image defect information; and
performing control to diagnose a malfunctioning part in the image forming unit, based on an image read by the reading unit,
wherein the diagnostic image is an image based on the acquired image defect information and setting information about the image forming unit.

10. The control method of the image forming apparatus according to claim 9, wherein the diagnostic image is an image generated based on the acquired image defect information and the setting information about the image forming unit.

11. The control method of the image forming apparatus according to claim 9, further comprising:
storing diagnosis information obtained by the control,
wherein the image defect information is the diagnosis information stored in the storing.

12. The control method of the image forming apparatus according to claim 9, wherein the control causes the image forming unit to form the diagnostic image as a first diagnostic image, and in a case where the image defect information is not acquired, causes the image forming unit to form a second diagnostic image.

13. The control method of the image forming apparatus according to claim 12, wherein the second diagnostic image is a diagnostic image that enables diagnosis of a malfunctioning part regardless of an image defect feature.

14. The control method of the image forming apparatus according to claim 12, wherein the first diagnostic image is limited in at least one of a number of image sheets, an amount of color material, a number of colors, and a print area, by the image defect information in contrast to the second diagnostic image.

15. The control method of the image forming apparatus according to claim 9, wherein the image defect information is information about at least one of a color, a shape, a period, a location, and a size of an image defect.

16. The control method of the image forming apparatus according to claim 9, wherein the setting information about the image forming unit is at least one of a sheet size and model information.
